(19) United States
(12) Patent Application Publication
(10) Pub. No.: US 2026/0163713 A1
(43) Pub. Date: Jun. 11, 2026

(54) TRANSMITTER AND RECEIVER ADOPTING CORRELATED SIGNALING FOR COMPENSATING FOR INTER-CHANNEL MISMATCH AND INTEGRATED CIRCUIT INCLUDING THE SAME

(71) Applicant: UIF (University Industry Foundation), Yonsei University, Seoul (KR)

(72) Inventors: Kwanseo PARK, Seoul (KR); Sinho LEE, Seoul (KR)

(21) Appl. No.: 19/400,400

(22) Filed: Nov. 25, 2025

(30) Foreign Application Priority Data
Dec. 5, 2024 (KR) 10-2024-0179872

(51) Int. Cl. H04L 7/033; H04L 7/00

(52) U.S. Cl. CPC H04L 7/033; H04L 7/0004; H04L 7/0008

(57) ABSTRACT

Provided is a transmitter adopting correlated signaling. The transmitter includes serializers and a phase interpolator configured to select a reference phase of a clock as any one of 0°, 90°, 180°, and 270° using a first code, fine-tune the selected reference phase by adding a phase selected using a second code thereto, and generate differential clocks using the fine-tuned reference phase, in which the phase selected using the second code is any one of 0°to 90°, and the differential clocks are used as synchronization clocks of each of the serializers.

### CROSS-REFERENCE TO RELATED APPLICATIONS

This application claims priority under 35 U.S.C. § 119(a) to Korean Patent Application No. 10-2024-0179872, filed in the Korean Intellectual Property Office on Dec. 5, 2024, the disclosure of each of which is hereby incorporated by reference in its entirety.

### BACKGROUND

The present disclosure relates to a transmitter, and more particularly, to a transmitter and a receiver adopting correlated signaling for compensating for inter-channel mismatch.

Conventional parallel transmitters and receivers have reduced and solved skew caused by mismatch between signal transmission lines by printing the signal transmission lines on a printed circuit board or in an integration process sufficiently to reduce the skew. This method has used an area of unnecessary signal transmission lines.

Correlated signaling refers to a technique used in communication systems to generate or use correlated signals.

In communication systems, correlated signaling is designed so that a plurality of signals have a certain correlation with each other. Correlated signaling can facilitate detection of desired signals or improve performance of communication systems.

Correlated signals are easier to detect, a correlation between signals is utilized to improve an energy efficiency of transmitted power, and correlated signaling can utilize correlated signals to suppress specific interference or enhance signal differentiation.

### SUMMARY

An object of the present disclosure is to provide a transmitter and a receiver adopting correlated signaling, which include a phase interpolator that selects a reference phase of a clock as any one of 0°, 90°, 180°, and 270°, fine-tunes the selected reference phase to any one of 0° to 90°, and generates differential clocks using the fine-tuned reference phase, and a device that can use the differential clocks as synchronous differential clocks, and an integrated circuit having the same to compensate for inter-channel mismatch that may occur in a process of printing channels on a printed circuit board or an integration process.

An exemplary embodiment of the present disclosure is directed to a transmitter, including serializers, and a phase interpolator configured to select a reference phase of a clock as one of 0°, 90°, 180°, and 270° using a first code, fine-tune the selected reference phase by adding a phase selected using a second code thereto, and generate differential clocks using the fine-tuned reference phase, in which the phase selected using the second code is any one of 0° to 90°, and the differential clocks are used as synchronization clocks of each of the serializers.

Another exemplary embodiment of the present disclosure is directed to a receiver, including a continuous time linear equalizer configured to receive a first channel signal input through a first channel and a second channel signal input through a second channel, a current mode amplifier configured to buffer output signals of the continuous time linear equalizer, a phase interpolator configured to select a reference phase of a clock as one of 0°, 90°, 180°, and 270° using a first code, fine-tune the selected reference phase by adding a selected phase using a second code thereto, and generate differential clocks using the fine-tuned reference phase, a first comparator configured to compare an output signal of the current mode amplifier with a first reference voltage using the differential clocks and output first bits, and a second comparator configured to compare the output signal of the current mode amplifier with a second reference voltage using the differential clocks and output second bits.

Still another exemplary embodiment of the present disclosure is directed to an integrated circuit, including a first transmitter, a second transmitter having the same structure as the first transmitter, a receiver, a first communication channel connected between a first output terminal of the first transmitter and a first input terminal of the receiver, and a second communication channel connected between a second output terminal of the second transmitter and a second input terminal of the receiver, in which the first transmitter includes serializers, and a phase interpolator configured to select a reference phase of a clock as any one of 0°, 90°, 180°, and 270° using a first code, fine-tune the selected reference phase by adding a phase selected using a second code thereto, and generate differential clocks using the fine-tuned reference phase, the phase selected using the second code is any one of 0° to 90°, and the differential clocks are used as synchronization clocks of each of the serializers.

The phase interpolator may include a first differential amplifier configured to select the reference phase as 0° using the first code having a first value, generate a first phase finely tuned between 0° and 90° by amplifying first differential input clocks in response to the second code, and generate the differential clocks using the first phase, a second differential amplifier configured to select the reference phase as 90° using the first code having a second value, generate a second phase finely tuned between 90° and 180° by amplifying second differential input clocks in response to the second code, and generate the differential clocks using the second phase, a third differential amplifier configured to select the reference phase as 180° using the first code having a third value, generate a third phase finely tuned between 180° and 270° by amplifying the first differential input clocks in response to the second code, and generate the differential clocks using the third phase, and a fourth differential amplifier configured to select the reference phase as 270° using the first code having a fourth value, generate a fourth phase finely tuned between 270° and 360° by amplifying the second differential input clocks in response to the second code, and generate the differential clocks using the third phase.

### BRIEF DESCRIPTION OF THE DRAWINGS

To more fully understand the drawings cited in the detailed description of the present disclosure, a detailed description of each drawing is provided.

FIG. 1 is a block diagram of a system including a transmitter and a receiver adopting correlated signaling according to an embodiment of the present disclosure;

FIG. 2 is a block diagram of a first transmitter shown in FIG. 1;

FIG. 3 is a block diagram of a first serializer circuit shown in FIG. 2;

FIG. 4 is a timing diagram of signals for describing an operation of an 8:4 serializer shown in FIG. 3;

FIG. 5 is a timing diagram of signals for describing an operation of a 4:2 serializer shown in FIG. 3;

FIG. 6 is a timing diagram of signals for describing an operation of a 2:1 serializer shown in FIG. 3;

FIG. 7 is a timing diagram of output signals of the first serializer circuit shown in FIG. 2;

FIG. 8 is a block diagram of a poly-phase filter circuit shown in FIG. 1;

FIG. 9 is a circuit diagram of a first poly-phase filter shown in FIG. 8;

FIG. 10 is a circuit diagram of a second poly-phase filter shown in FIG. 8;

FIG. 11 is a circuit diagram of a phase interpolator shown in FIG. 1;

FIG. 12 is a conceptual diagram for describing an operation of the phase interpolator shown in FIG. 11;

FIG. 13 is a block diagram of a latch-based retimer shown in FIG. 1;

FIG. 14 is a timing diagram of output signals of the latch-based retimer shown in FIG. 13;

FIG. 15 is a circuit diagram of a first voltage driver included in a feed-forward equalizer shown in FIG. 1;

FIG. 16 is a timing diagram of output signals of the feed-forward equalizer shown in FIG. 1;

FIG. 17 is a block diagram of a first receiver shown in FIG. 1; and

FIG. 18 is a block diagram of a dummy transmitter shown in FIG. 1.

### DETAILED DESCRIPTION OF THE EMBODIMENTS

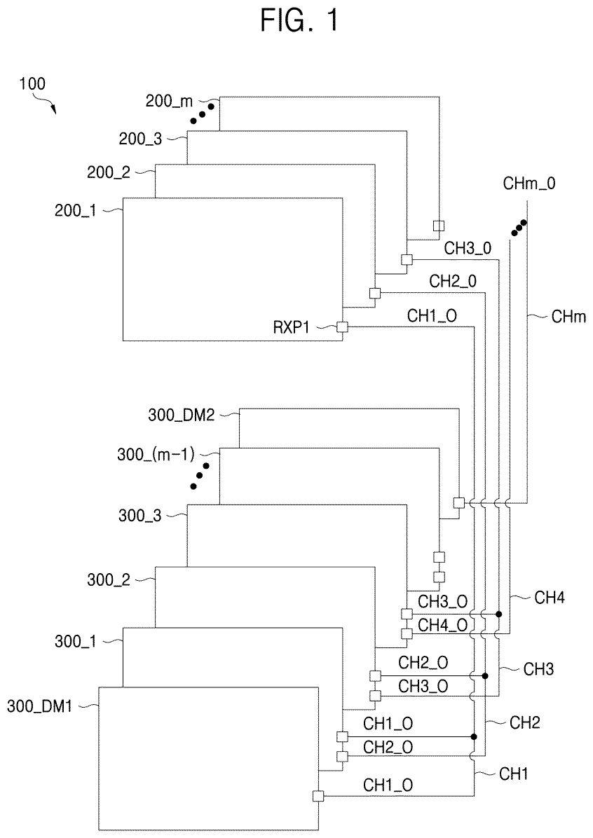

FIG. 1 is a block diagram of a system including a transmitter and a receiver adopting correlated signaling according to an embodiment of the present disclosure.

Referring to FIG. 1, a system 100 is a transmitter system configured to transmit and receive wired signals over a short distance. The system 100 may be a central processing unit (CPU), a graphics processing unit (GPU), a tensor processing unit (TPU), a neural processing unit (NPU), an application-specific integrated circuit (ASIC), a field-programmable gate array (FPGA), a System on Chip (SoC), or a system integrated within memory device, but the present disclosure is not limited thereto.

The system 100 includes a plurality of transmitters 200_1 to 200_m, a plurality of receivers 300_1 to 300_(m−1), a plurality of dummy receivers 300_DM1 and 300_DM2, and a plurality of signal transmission lines CH1 to CHm, also referred to as “communication channels” or “channels.” Where m is a natural number greater than or equal to 2, and for convenience of description in the present specification, m is assumed to be 8.

The system 100 includes parallel transmitters adopting correlated signaling and has a structure which can compensate for inter-channel mismatch. For example, the correlated signaling is a technique used to analyze a correlation between two signals to extract specific characteristics, measure similarity, or analyze frequency components of a signal.

For example, increased jitter noise due to inter-channel mismatch is compensated for or eliminated by two corresponding receivers 300_i and 300_(i+1), where i is any one of 1 to 7, and 1≤i≤(m−1).

A first dummy receiver 300_DM1 receives and processes a first channel signal CH1_0 of a first transmitter 200_1 through a first channel CH1.

A second receiver 300_2 receives and processes a second channel signal CH2_0 of a second transmitter 200_2 received through a second channel CH2 and a third channel signal CH3_0 of a third transmitter 200_3 received through a third channel CH3. A seventh receiver 300_7 receives and processes a seventh channel signal of a seventh transmitter received through a seventh channel CH7 and an eighth channel signal CH8_0 of an eighth transmitter 200_8 received through an eighth channel CH8.

A second dummy receiver 300_DM2 receives and processes the eighth channel signal CH8_0 of the eighth transmitter 200_8 received through the eighth channel CH8.

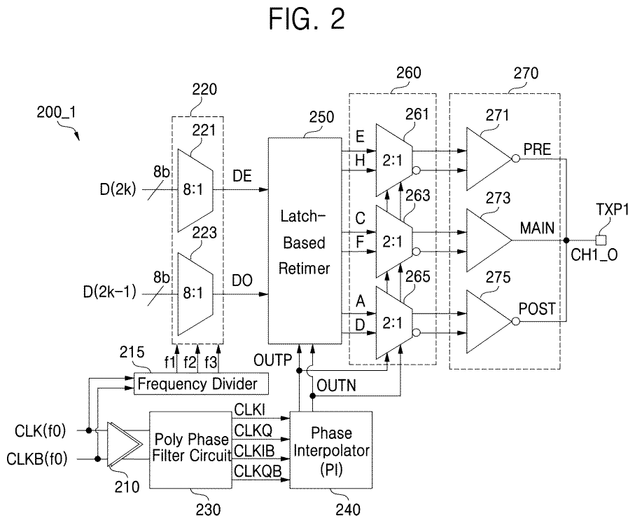

FIG. 2 is a block diagram of the first transmitter shown in FIG. 1. Referring to FIGS. 1 and 2, since the eight transmitters 200_1 to 200_8 are identical in structure and operation, a structure and an operation of the first transmitter 200_1 will be described in detail with reference to FIG. 2.

The first transmitter 200_1 includes a clock buffer 210, a frequency divider (or clock divider) 215, a first serializer circuit 220, a poly-phase filter (PPF) circuit 230, a phase interpolator 240, a latch-based retimer 250, a second serializer circuit 260, and a feed-forward equalizer (FFE) 270.

Input differential clocks CLK(f0) and CLKB(f0) Are Input to the Frequency Divider 215.

The clock buffer 210 buffers each of the input differential clocks CLK(f0) and CLKB(f0) and outputs the buffered differential clocks to the poly-phase filter (PPF) circuit 230. Each of the input differential clocks CLK(f0) and CLKB(f0) has a clock frequency f0.

The frequency divider 215 divides each of the input differential clocks CLK(f0) and CLKB(f0) having the clock frequency f0 by different division ratios to generate divided differential clocks having different frequencies f1, f2, and f3.

The first serializer circuit 220 includes a first input serializer circuit 221 and a second input serializer circuit 223.

The first input serializer circuit 221 serializes a first parallel data D(2k) using divided differential clocks to generate a first input data ED. For example, the first parallel data D(2k) is an 8-bit parallel data, and the first input data ED is a 1-bit data. According to the embodiment, the first input serializer circuit 221 may be an 8:1 serializer.

The second input serializer circuit 223 serializes a second parallel data D(2k−1) using the divided differential clocks to generate a second input data EO. For example, the second parallel data D(2k−1) is an 8-bit parallel data, and the second input data EO is a 1-bit data. According to the embodiment, the second input serializer circuit 223 may be an 8:1 serializer.

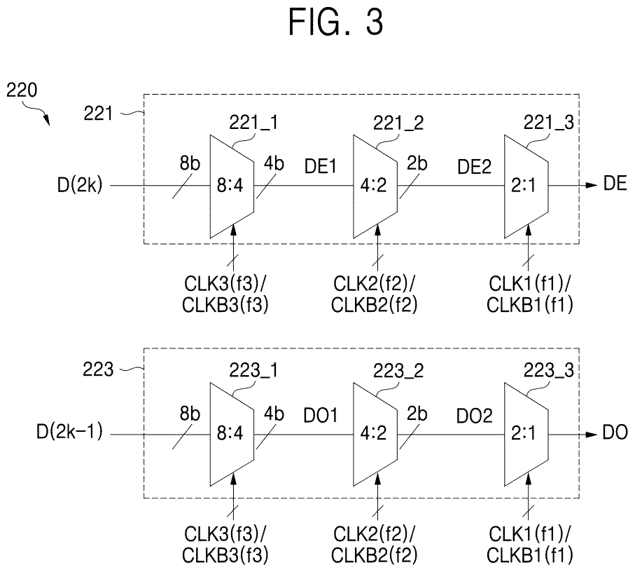

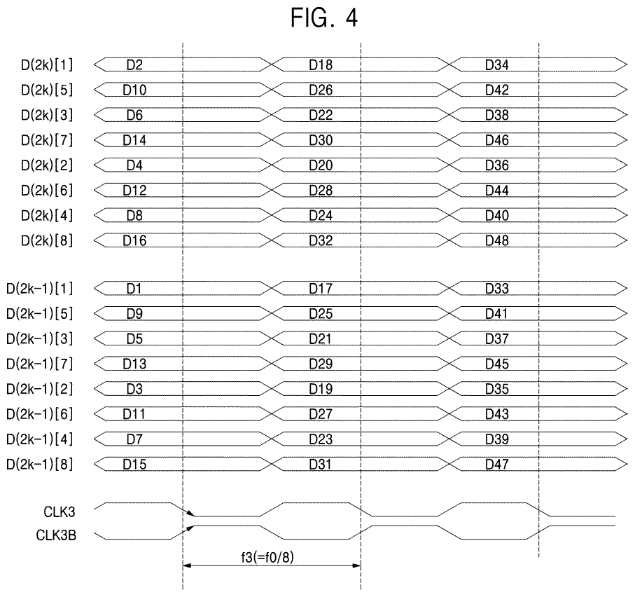

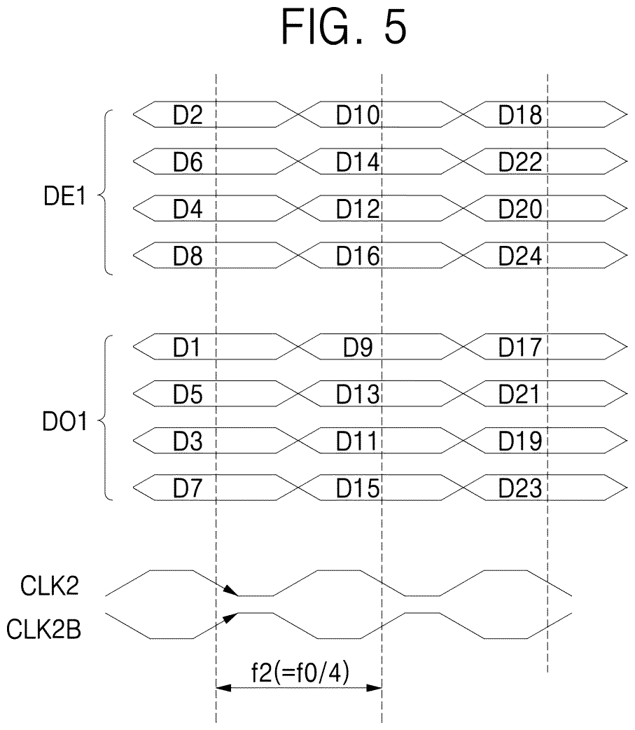

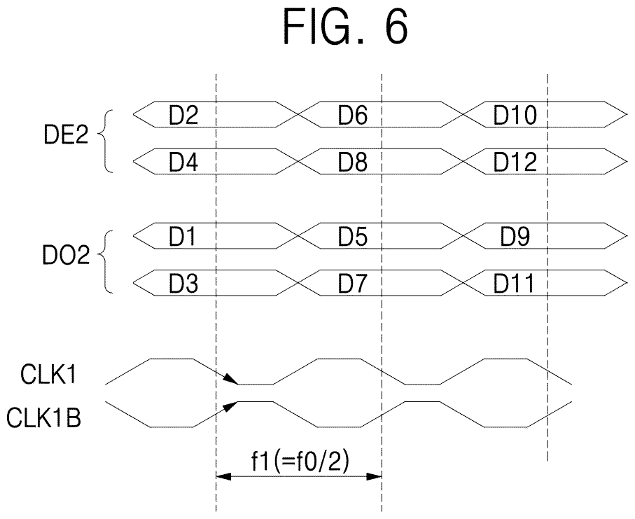

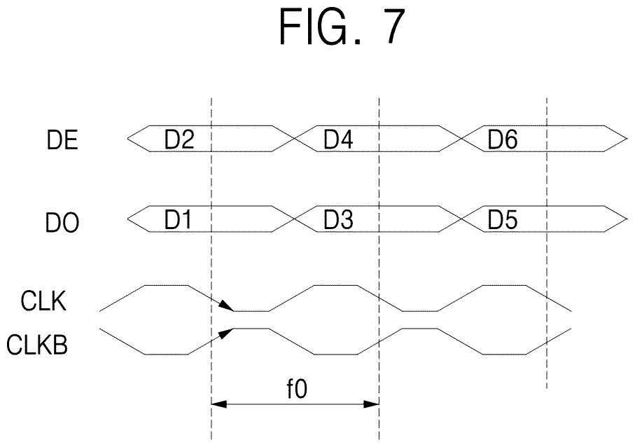

FIG. 3 is a block diagram of the first serializer circuit shown in FIG. 2, FIG. 4 is a timing diagram of signals for describing an operation of an 8:4 serializer shown in FIG. 3, FIG. 5 is a timing diagram of signals for describing an operation of a 4:2 serializer shown in FIG. 3, FIG. 6 is a timing diagram of signals for describing an operation of a 2:1 serializer shown in FIG. 3, and FIG. 7 is a timing diagram of output signals of the first serializer circuit shown in FIG. 2.

Referring to FIGS. 2 to 7, the divided differential clocks divided by the frequency divider 215 include first divided differential clocks CLK3(f3) and CLKB3(f3) generated by dividing the clock frequency f0 by a first division ratio (e.g., 8), second divided differential clocks CLK2(f2) and CLKB2(f2) generated by dividing the clock frequency f0 by a second division ratio (e.g., 4), and third divided differential clocks CLK1(f1) and CLKB1(f1) generated by dividing the clock frequency f0 by a third division ratio (e.g., 2).

For example, a frequency of each of the first divided differential clocks CLK3(f3) and CLKB3(f3) is f0/8, a frequency of each of the second divided differential clocks CLK2(f2) and CLKB2(f2) is f0/4, and a frequency of each of the third divided differential clocks CLK1(f1) and CLKB1(f1) is f0/2.

The first input serializer circuit 221 includes a first serializer 221_1, a second serializer 221_2, and a Third Serializer 221_3.

The first serializer 221_1 serializes N-bit (e.g., N is a natural number greater than or equal to 2, and N is 8) first parallel data D(2k) using the first divided differential clocks CLK3(f3) and CLKB3(f3) to generate a first input N/2-bit parallel data DE1.

The second serializer 221_2 serializes the first input N/2-bit parallel data DE1 using the second divided differential clocks CLK2(f2) and CLKB2(f2) to generate a first input N/4-bit parallel data DE2.

The third serializer 221_3 serializes the first input N/4-bit parallel data DE2 using the third divided differential clocks CLK1(f1) and CLKB1(f1) to generate a first input N/8-bit parallel data, i.e., the first input data ED.

The second input serializer circuit 223 includes a fourth serializer 223_1, a fifth serializer 223_2, and a sixth serializer 223_3.

The fourth serializer 223_1 serializes an N-bit (here, N is 8) second parallel data D(2k−1) using the first divided differential clocks CLK3(f3) and CLKB3(f3) to generate a second input N/2-bit parallel data DO1.

The fifth serializer 223_2 serializes the second input N/2-bit parallel data DO1 using the second divided differential clocks CLK2(f2) and CLKB2(f2) to generate a second input N/4-bit parallel data DO2.

The sixth serializer 223_3 serializes the second input N/4-bit parallel data DO2 using the third divided differential clocks CLK1(f1) and CLKB1(f1) to generate a second input N/8-bit parallel data, i.e., the second input data EO.

The first serializer 221_1 and the fourth serializer 223_1 can each be an 8:4 serializer. The serializers 221_1 and 223_1 serialize 8-bit parallel data D(2k) and D(2k−1) according to the timing diagram shown in FIG. 4 to generate 4-bit parallel data DE1 and DO1, respectively.

The second serializer 221_2 and the fifth serializer 223_2 can each be a 4:2 serializer. The serializer 221_2 and 223_2 serialize the 4-bit parallel data DE1 and DO1 according to the timing diagram shown in FIG. 5 to generate 2-bit parallel data DE2 and DO2, respectively.

The third serializer 221_3 and the sixth serializer 223_3 can each be a 2:1 serializer. The serializer 221_3 and 223_3 serialize the 2-bit parallel data DE2 and DO2 according to the timing diagram shown in FIG. 6 to generate 1-bit data DE and DO, respectively.

Referring to the timing diagram shown in FIG. 7, the first serializer circuit 220 can serialize the 8-bit parallel data D(2k) and D(2k−1) and finally output each of the 1-bit input data DE and DO. D1 to D48 shown in FIGS. 4 through 7 represent 1-bit data and can indicate an order of data.

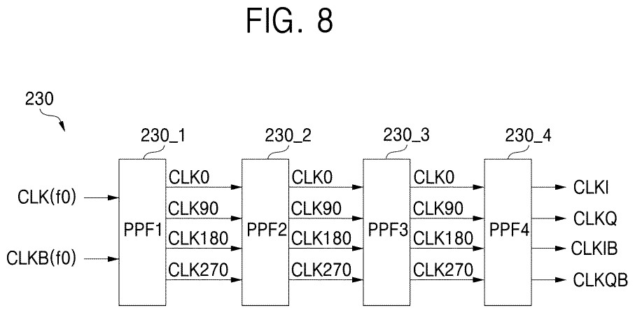

FIG. 8 is a block diagram of the poly-phase filter circuit shown in FIG. 1. Referring to FIGS. 1 and 8, the poly-phase filter circuit 230 includes a plurality of poly-phase filters 230_1 to 230_4.

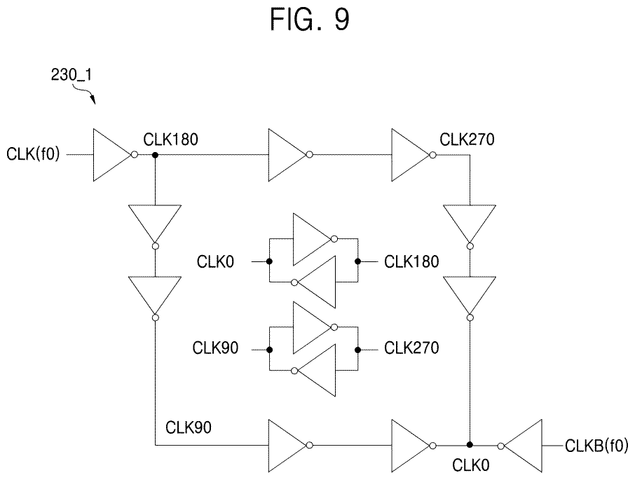

FIG. 9 is a circuit diagram of a first poly-phase filter shown in FIG. 8. Referring to FIGS. 8 and 9, a first poly-phase filter 230_1 includes a plurality of inverters. When some of the plurality of inverters are designed to have a delay, the first poly-phase filter 230_1 generates four clocks CLK0, CLK90, CLK180, and CLK270 each having a phase difference of 90°, as shown in FIG. 9, and outputs them to a second poly-phase filter 230_2.

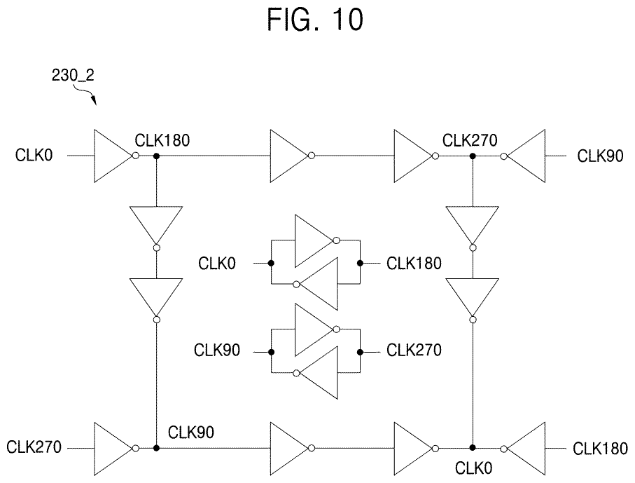

FIG. 10 is a circuit diagram of the second poly-phase filter shown in FIG. 8. Referring to FIGS. 8 and 10, the poly-phase filters 230_2 to 230_4 are identical in structure and operation. Therefore, a structure and an operation of the second poly-phase filter 230_2 will be described in detail.

The second poly-phase filter 230_2 includes a plurality of inverters. When some of the plurality of inverters are designed to have a delay, the second poly-phase filter 230_2 generates four clocks CLK0, CLK90, CLK180, and CLK270 each having a phase difference of 90°, as shown in FIG. 10, and transmits them to a third poly-phase filter 230_3.

The third poly-phase filter 230_3 generates four clocks CLK0, CLK90, CLK180, and CLK270 each having a phase difference of 90°, and transmits them to a fourth poly-phase filter 230_4.

The fourth poly-phase filter 230_4 generates four clocks CLK0, CLK90, CLK180, and CLK270 each having a phase difference of 90°. At this time, CLK0 is identical to CLKI, CLK90 is identical to CLKQ, CLK180 is identical to CLKIB, and CLK270 is identical to CLKQB. CLKI and CLKIB are differential clocks, and CLKQ and CLKQB are differential clocks.

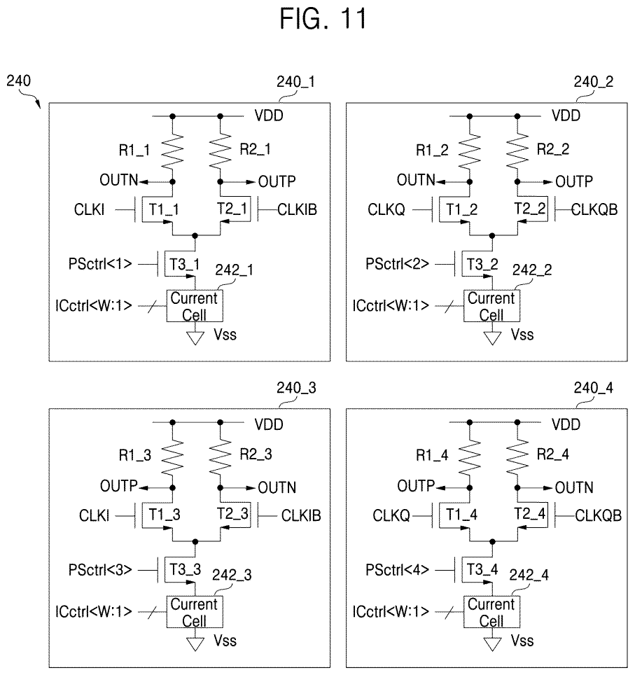

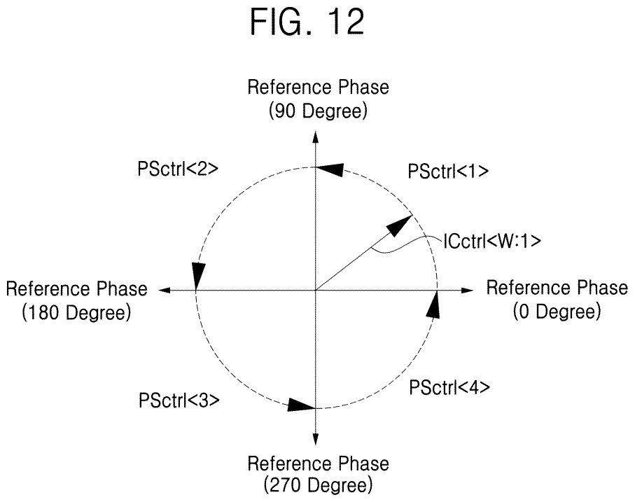

FIG. 11 is a circuit diagram of the phase interpolator shown in FIG. 1, and FIG. 12 is a conceptual diagram for describing an operation of the phase interpolator shown in FIG. 11. Referring to FIGS. 11 and 12, the phase interpolator 240 includes a plurality of differential amplifiers (also referred to as “mixers”) 240_1 to 240_4.

The phase interpolator 240 selects a reference phase of a clock as any one of 0°, 90°, 180°, and 270° using a corresponding first code PSctrl<1>, PSctrl<2>, PSctrl<3>, or PSctrl<4>, fine-tunes the selected reference phase by adding a phase selected using a W-bit second code ICctrl(<W:1>) thereto, and generates differential clocks OUTP and OUTN using the fine-tuned reference phase.

For example, a first code generator may generate respective first codes PSctrl<1>, PSctrl<2>, PSctrl<3>, and PSctrl<4>in response to a 2-bit data. In this case, when the 2-bit data is 2′b00, the first code generator generates a first code PSctrl<1> or a first phase control signal PSctrl<1> having a high level. When the 2-bit data is 2′b01, the first code generator generates a first code PSctrl<2> or a second phase control signal PSctrl<2> having a high level. When the 2-bit data is 2′b10, the first code generator generates a first code PSctrl<3> or a third phase control signal PSctrl<3> having a high level. When the 2-bit data is 2′b11, the first code generator can generate a first code PSctrl<4> or a fourth phase control signal PSctrl<4> having a high level.

In this case, the phase selected using the W-bit second code Icctrl(<W:1>) is any one of 0° to 90°. Here, W is a natural number greater than or equal to 2, and for the convenience of description, W is assumed to be 32. The differential clocks OUTP and OUTN can be used as synchronization clocks (or operating clocks) of the latch-based retimer 250 and each of serializers 261, 263, and 265.

Types of differential amplifiers 240_1 and 240_2 may be different from types of differential amplifiers 240_3 and 240_4. For example, the differential amplifiers 240_1 and 240_2 may be inverting differential amplifiers, and the differential amplifiers 240_3 and 240_4 may be non-inverting differential amplifiers, but the present disclosure is not limited thereto.

The differential amplifier may refer to a clock generator. Each of the differential amplifiers 240_1 to 240_4 has an identical structure.

A first differential amplifier 240_1 may select the reference phase as 0° using the first code PSctrl<1> having a first value (e.g., ‘high level’ or ‘logic 1’), generate a first phase finely tuned between 0° and 90° by amplifying a difference between first differential input clocks CLKI and CLKIB in response to a 32-bit second code ICctrl(<32:1>), and generate the differential clocks OUTP and OUTN using the first phase.

The first differential amplifier 240_1 includes resistors R1_1 and R2_1 for supplying an operating voltage VDD to amplifying NMOS transistors T1_1 and T2_1, a bias (or selecting) NMOS transistor T3_1, and a phase fine-tuning current cell 242_1.

For example, each of phase fine-tuning current cells 242_1, 242_2, 242_3, and 242_4 may include 32 parallel switches that are turned on or off in response to each of 32-bit parallel control signals included in the second code Icctrl(<32:1>).

When the first code PSctrl<1> having the first value is supplied to a bias NMOS transistor T3_1, the phase interpolator 240 selects the reference phase as 0°.

When the 32-bit second code ICctrl(<32:1>) is adjusted, a current flowing through the first differential amplifier 240_1 is adjusted by the phase fine-tuning current cell 242_1. Therefore, the phase interpolator 240 may generate a first phase (e.g., 0°<first phase<90°) finely tuned between 0° and 90° and generate the differential clocks OUTP and OUTN using the first phase.

For example, when the 32-bit second code ICctrl(<32:1>) is all 1, the first phase can be a phase very close to 90°, and when a least significant bit (LSB) of the 32-bit second code ICctrl(<32:1>) is 1 and the remaining 31 bits are all 0, the first phase may be a phase slightly greater than 0°.

A second differential amplifier 240_2 may select the reference phase as 90° using the first code PSctrl<2> having a second value (e.g., ‘high level(or data 1)’ or ‘logic 1(or data 0)’), generate a second phase (e.g., 90°<second phase<180°) finely tuned between 90° and 180° by amplifying a difference between the second differential input clocks CLKQ and CLKQB in response to the 32-bit second code ICctrl(<32:1>), and generate the differential clocks OUTP and OUTN using the second phase.

The second differential amplifier 240_2 includes resistors R1_2 and R2_2 for supplying the operating voltage VDD to amplifying NMOS transistors T1_2 and T2_2, a bias (or selection) NMOS transistor T3_2, and a phase fine-tuning current cell 242_2.

When the first code PSctrl<2> having the second value is supplied to the bias NMOS transistor T3_2, the phase interpolator 240 selects the reference phase as 90°.

When the 32-bit second code ICctrl(<32:1>) is adjusted, a current flowing through the second differential amplifier 240_2 is adjusted by the phase fine-tuning current cell 242_2. Therefore, the phase interpolator 240 may generate a second phase finely tuned between 90° and 180° and generate the differential clocks OUTP and OUTN using the second phase.

For example, when the 32-bit second code ICctrl(<32:1>) is all 1, the second phase may be a phase very close to 180°, and when the LSB of the 32-bit second code ICctrl(<32:1>) is 1 and the remaining 31 bits are all 0, the second phase may be a phase slightly greater than 90°.

A third differential amplifier 240_3 may select the reference phase as 180° using the first code PSctrl<3> having a third value (e.g., ‘high level’ or ‘logic 1’), generate a third phase (e.g., 180°<third phase<270°) finely tuned between 180° and 270° by amplifying a difference between the first differential input clocks CLKI and CLKIB in response to the 32-bit second code ICctrl(<32:1>), and generate the differential clocks OUTP and OUTN using the third phase.

The third differential amplifier 240_3 includes resistors R1_3 and R2_3 for supplying the operating voltage VDD to amplifying NMOS transistors T1_3 and T2_3, a bias (or selection) NMOS transistor T3_3, and a phase fine-tuning current cell 242_3.

When the first code PSctrl<3> having the third value is supplied to the bias NMOS transistor T3_3, the phase interpolator 240 selects the reference phase as 180°.

When the 32-bit second code ICctrl(<32:1>) is adjusted, a current flowing through the third differential amplifier 240_3 is adjusted by the phase fine-tuning current cell 242_3. Therefore, the phase interpolator 240 may generate a third phase finely tuned between 180° and 270° and generate the differential clocks OUTP and OUTN using the third phase.

For example, when the 32-bit second code ICctrl(<32:1>) is all 1, the third phase may be a phase very close to 270°, and when the LSB of the 32-bit second code ICctrl(<32:1>) is 1 and the remaining 31 bits are all 0, the third phase may be a phase slightly greater than 180°.

A fourth differential amplifier 240_4 may select the reference phase as 270° using the first code PSctrl<4> having a fourth value (e.g., ‘high level’ or ‘logic 1’), generate a fourth phase (e.g., 270°<fourth phase<360°) finely tuned between 270° and 360° by amplifying the difference between the second differential input clocks CLKQ and CLKQB in response to the 32-bit second code ICctrl(<32:1>), and generate the differential clocks OUTP and OUTN using the fourth phase.

The fourth differential amplifier 240_4 includes resistors R1_4 and R2_4 for supplying the operating voltage VDD to amplifying NMOS transistors T1_4 and T2_4, a bias (or selection) NMOS transistor T3_4, and a phase fine-tuning current cell 242_4.

When the first code PSctrl<4> having the fourth value is supplied to the bias NMOS transistor T3_4, the phase interpolator 240 selects the reference phase as 270°.

When the 32-bit second code ICctrl(<32:1>) is adjusted, a current flowing through the fourth differential amplifier 240_4 is adjusted by the phase fine-tuning current cell 242_4. Therefore, the phase interpolator 240 may generate a fourth phase finely tuned between 270° and 360° and generate the differential clocks OUTP and OUTN using the fourth phase.

For example, when the 32-bit second code ICctrl(<32:1>) is all 1, the fourth phase may be very close to 360°. When the LSB of the 32-bit second code ICctrl(<32:1>) is 1 and the remaining 31 bits are all 0, the fourth phase may be slightly greater than 270°.

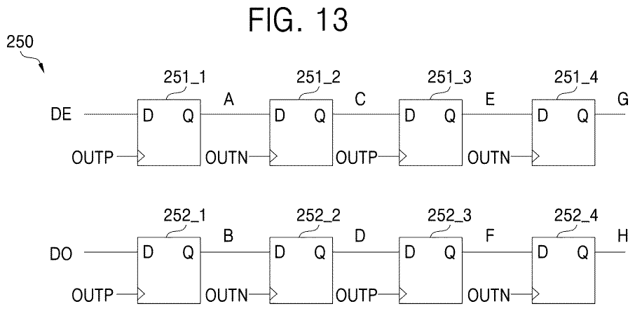

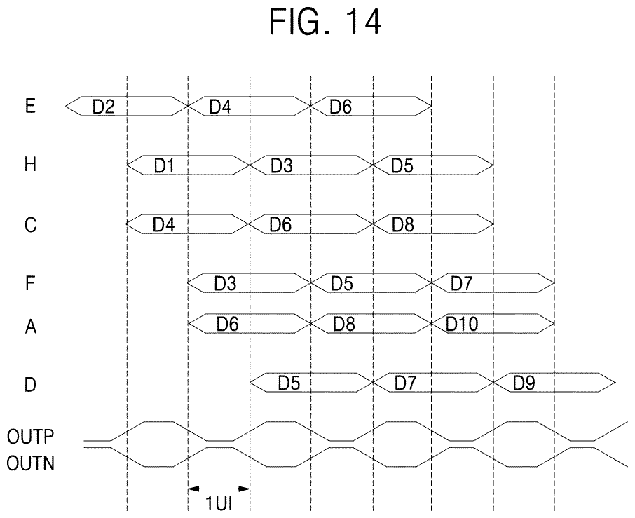

FIG. 13 is a block diagram of the latch-based retimer shown in FIG. 1, and FIG. 14 is a timing diagram of output signals of the latch-based retimer shown in FIG. 13.

The latch-based retimer 250 is an electronic system for correcting signal timing and maintaining data integrity. It synchronizes input signals DE and DO to the differential clocks OUTP and OUTN and outputs output signals E and H, C and F, and A and A at accurate timings, thereby reducing signal jitter.

The latch-based retimer 250 includes a first shift register including a plurality of flip-flops 251_1 to 251_4 that operate based on the differential clocks OUTP and OUTN whose phases are controlled by the phase interpolator 240, and a second shift register including a plurality of flip-flops 252_1 to 252_4 that operate based on the differential clocks OUTP and OUTN.

Odd-numbered flip-flops 251_1 and 251_3 among the plurality of flip-flops 251_1 to 251_4 that sequentially process a 1-bit first input data DE perform a latch operation using a clock OUTP among the differential clocks OUTP and OUTN, and even-numbered flip-flops 251_2 and 251_4 among the plurality of flip-flops 251_1 to 251_4 perform a latch operation using an inverted clock OUTN among the differential clocks OUTP and OUTN. The first shift register outputs first parallel bits (ACE).

Odd-numbered flip-flops 252_1 and 252_3 among the plurality of flip-flops 252_1 to 252_4 that sequentially process a 1-bit second input data DO perform a latch operation using the clock OUTP among the differential clocks OUTP and OUTN, and even-numbered flip-flops 252_2 and 252_4 among the plurality of flip-flops 252_1 to 252_4 perform a latch operation using the inverted clock OUTN among the differential clocks OUTP and OUTN.

The second shift register outputs second parallel bits (DFH).

The second serializer circuit 260 includes seventh to ninth serializers 261, 263, and 265 which perform a serialization operation on the basis of the differential clocks OUTP and OUTN whose phases are controlled by the phase interpolator 240.

Each of the serializers 261, 263, and 265 may be a 2:1 serializer, and an operation of each of the serializer 261, 263, and 265 is identical or similar to that of each of the 2:1 serializers 221_3 and 223_3 described with reference to FIGS. 3 and 6. Therefore, a detailed description of the operation of each of the 2:1 serializers 261, 263, and 265 will be omitted.

A seventh serializer 261 may serialize a first bit (H) of the second parallel bits (DFH), which is paired with a first bit (E) of the first parallel bits (ACE) on the basis of the differential clocks OUTP and OUTN, generate first differential signals, and transmit them to a first voltage driver 271.

An eighth serializer 263 may serialize a second bit (F) of the second parallel bits (DFH), which is paired with a second bit (C) of the first parallel bits (ACE) on the basis of the differential clocks OUTP and OUTN, generate second differential signals, and transmit them to a second voltage driver 273.

A ninth serializer 265 may serialize a third bit (D) of the second parallel bits (DFH), which is paired with a third bit (A) of the first parallel bits (ACE) on the basis of the differential clocks OUTP and OUTN, generate third differential signals, and transmit them to a third voltage driver 275. Referring to FIG. 14, the latch-based retimer 250 may generate signals E and H, C and F, and A and D delayed by a unit interval (UI).

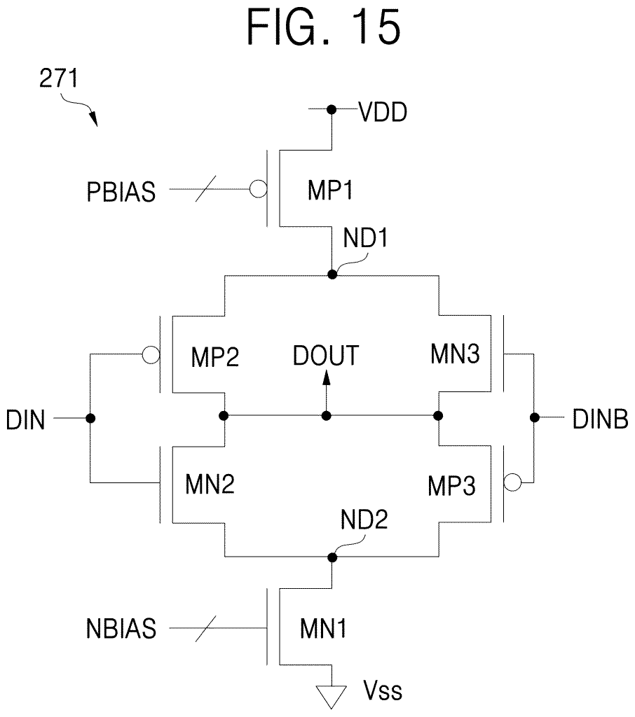

FIG. 15 is a circuit diagram of the first voltage driver included in the feed-forward equalizer shown in FIG. 1. Referring to FIGS. 1 and 15, the feed-forward equalizer 270 includes the first voltage driver 271, the second voltage driver 273, and the third voltage driver 275.

Referring to FIG. 15, the first voltage driver 271 includes a single unit voltage driver.

A unit voltage driver corresponding to the first voltage driver 271 includes a plurality of PMOS transistors MP1 connected in parallel between a power line for supplying the operating voltage VDD and a first node ND1 and receiving first bias bits (PBIAS), transistors MP2 and MN2 connected in series between nodes ND1 and ND2, transistors MN3 and MP3 connected in series between the nodes ND1 and ND2, and a plurality of NMOS transistors MN1 connected in parallel between a second node ND2 and a ground Vss and receiving second bias bits (NBIAS), respectively.

The second voltage driver 273 includes a plurality of parallel-connected unit voltage drivers 271, and the third voltage driver 275 includes a plurality of parallel-connected unit voltage drivers 271.

The number of unit voltage drivers 271 included in the second voltage driver 273 is greater than the number of unit voltage drivers 271 included in the third voltage driver 275, and the number of unit voltage drivers 271 included in the third voltage driver 275 is greater than the number of unit voltage drivers 271 included in the first voltage driver 271.

For example, a voltage driving capability of the second voltage driver 273 is greater than that of the third voltage driver 275, and the voltage driving capability of the third voltage driver 275 is greater than that of the first voltage driver 271.

The unit voltage driver 271 included in the first voltage driver 271 generates a first output signal DOUT=PRE by amplifying a difference between first differential signals DIN and DINB generated by the seventh serializer 261 and inverting an amplified signal, and outputs this signal DOUT=PRE to an output terminal TXP1.

Each of the plurality of unit voltage drivers 271 included in the second voltage driver 273 generates a second output signal DOUT=MAIN by amplifying a difference between second differential signals DIN and DINB generated by the eighth serializer 263, and outputs this signal DOUT=MAIN to the output terminal TXP1.

Each of the plurality of unit voltage drivers 271 included in the third voltage driver 275 generates a third output signal DOUT=POST by amplifying a difference between differential signals DIN and DINB generated by the ninth serializer 265 and inverting an amplified signal, and outputs this signal DOUT=POST to the output terminal TXP1.

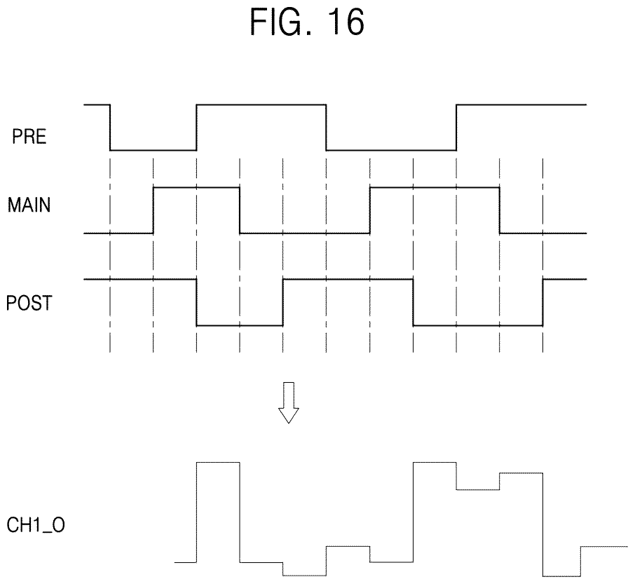

FIG. 16 is a timing diagram of output signals of the feed-forward equalizer shown in FIG. 1. Referring to FIGS. 1, 15, and 16, respective output signals PRE, MAIN, and POST of each of the voltage drivers 271, 273, and 275 including different numbers of unit voltage drivers are combined at the output terminal TXP1 to be generated as the first channel signal CH1_O. The first channel signal CH1_O is transmitted to a first receiving terminal of a first receiver 300_1 and a receiving terminal of a first dummy receiver 300_D1.

A process in which each of the transmitters 200_2 to 200_8 generates respective channel signals CH2_0 to CH8_O is identical to or similar to a process in which the first transmitter 200_1 generates the first channel signal CH1_O.

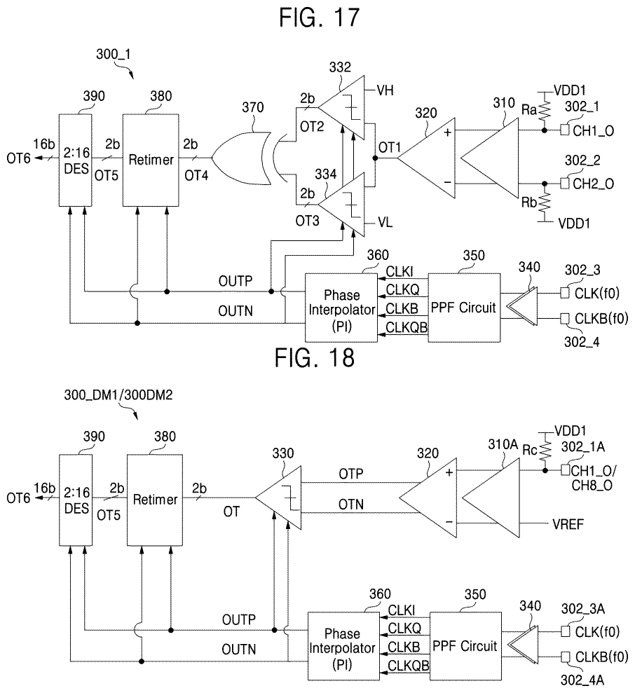

FIG. 17 is a block diagram of the first receiver shown in FIG. 1. Referring to FIGS. 1 and 17, receivers 300_1 to 300_(m−1) are identical in structure and operation, so that a structure and an operation of the receiver 300_1 will be described in detail.

The first receiver 300_1 includes a first receiving terminal 302_1 for receiving the first channel signal CH1_O transmitted through the first channel CH1 connected to the first transmitter 200_1, a second receiving terminal 302_2 for receiving a second channel signal CH2_O transmitted through the second channel CH2 connected to the second transmitter 200_2, clock receiving terminals 302_3 and 302_4 for receiving the differential clocks CLK(f0) and CLKB(f0), a first amplifier 310, a second amplifier 320, a first comparator 332, a second comparator 334, a clock buffer 340, a PPF circuit 350, a phase interpolator 360, an XOR circuit 370, a retimer 380, and a deserializer 390.

The first receiver 300_1 may further include a resistor Ra connected between a power line for transmitting a receiver operating voltage VDD1 and the first receiving terminal 302_1, and a resistor Rb connected between the power line and the second receiving terminal 302_2.

The first amplifier 310 generates differential signals by amplifying a difference between the first channel signal CH1_O received through the first receiving terminal 302_1 and the second channel signal CH2_O received through the second receiving terminal 302_2 and transmit them to the second amplifier 320.

According to embodiments, the first amplifier 310 may be a continuous time linear equalizer (CTLE) or a buffer.

The second amplifier 320 amplifies a difference between the differential signals output from the first amplifier 310 and transmits an amplified signal OT1 to the first comparator 332 and the second comparator 334.

According to embodiments, the second amplifier 320 may be a current mode logic (Current Mode Logic (CML) circuit, a current mode amplifier.

The first comparator 332 compares the output signal OT1 of the second amplifier 320 with a first reference voltage VH using the differential clocks OUTP and OUTN output from the phase interpolator 360 and outputs first bits OT2 corresponding to a result of the comparison. The second comparator 334 compares the output signal OT1 of the second amplifier 320 with a second reference voltage VL using the differential clocks OUTP and OUTN and outputs second bits OT3 corresponding to a result of the comparison. According to embodiments, the first bits OT2 are 2 bits, and the second bits OT3 are 2 bits. Each of the comparators 332 and 334 may be a sampler or a Schmitt trigger.

The clock buffer 340 buffers the input differential clocks CLK(f0) and CLKB(f0) output from the clock receiving terminals 302_3 and 302_4 and outputs the buffered differential clocks to the PPF circuit 350.

A structure and an operation of the PPF circuit 350 included in the first receiver 300_1 are identical to those of the PPF circuit 230 included in the first transmitter 200_1, and therefore, a description of the PPF circuit 350 will be omitted. A structure and an operation of the phase interpolator 360 included in the first receiver 300_1 are identical to those of the phase interpolator 240 included in the first transmitter 200_1, and therefore, a description of the phase interpolator 360 will be omitted.

A logic circuit, for example, the XOR circuit 370, generates third bits OT4 by performing an XOR operation on the first bits OT2 output from the first comparator 332 and the second bits OT3 output from the second comparator 334 bit by bit and outputs them to the retimer 380. According to the embodiment, the third bits OT4 may be 2 bits.

The retimer 380 reorders the third bits OT4 and outputs the reordered fourth bits OT5, e.g., 2 bits, to the deserializer 390 using the differential clocks OUTP and OUTN output from the phase interpolator 360.

The retimer 380 may synchronize the input signals OT4 to the differential clocks OUTP and OUTN and output the output signals OT5 at accurate timings.

The deserializer 390 deserializes the fourth bits OT5 output from the retimer 380 and generates parallel data OT6 using the differential clocks OUTP and OUTN output from the phase interpolator 360. The deserializer 390 may be a 2:16 deserializer, and the deserializer 390 may deserialize the 2-bit parallel data OT5 to generate a 16-bit parallel data OT6.

FIG. 18 is a block diagram of the dummy transmitter shown in FIG. 1. Referring to FIGS. 1 and 18, the first dummy receiver 300_DM1 and the second dummy receiver 300_DM2 are identical in structure, so that a structure and an operation of the first dummy receiver 300_DM1 will be described.

Unlike the receivers 300_1 to 300_7, each dummy receiver 300_DM1 or 300_DM2 receives a single channel signal CH1_0 or CH8_O transmitted through a single channel CH1 or CH8.

The first dummy receiver 300_DM1 includes a first receiving terminal 302_1A for receiving the first channel signal CH1_O transmitted through the first channel CH1 connected to the first transmitter 200_1, clock receiving terminals 302_3A and 302_4A for receiving the input differential clocks CLK(f0) and CLKB(f0), a first amplifier 310A, the second amplifier 320, a third amplifier 330, the clock buffer 340, the PPF circuit 350, the phase interpolator 360, the retimer 380, and the deserializer 390.

The first dummy receiver 300_DM1 may further include a resistor Rc connected between the power line for transmitting the receiver operating voltage VDD1 and the first receiving terminal 302_1.

The first amplifier 310A amplifies the difference between the first channel signal CH1_O received through the first receiving terminal 302_1A and a reference voltage VREF and outputs differential signals to the second amplifier 320. According to the embodiments, the first amplifier 310A may be a continuous time linear equalizer (CTLE) or a buffer.

The second amplifier 320 amplifies a difference between the differential signals transmitted from the first amplifier 310A and transmits amplified differential signals OTP and OTN to the third amplifier 330. According to the embodiments, the second amplifier 320 may be a current mode logic (CML) circuit, or a current mode amplifier.

The third amplifier 330, using the differential clocks OUTP and OUTN output from the phase interpolator 360, generates an amplified signal OT by amplifying a difference between the differential signals OTP and OTN output from the second amplifier 320 and outputs it to the retimer 380. The output signal OT may be 2 bits, and the third amplifier 330 may be a sampler or a Schmitt trigger.

The clock buffer 340 buffers the differential clocks CLK(f0) and CLKB(f0) output from the clock receiving terminals 302_3A and 302_4 and outputs the buffered differential clocks to the PPF circuit 350.

A structure and an operation of the PPF circuit 350 included in the first dummy receiver 300_DM1 are identical to those of the PPF circuit 230 included in the first transmitter 200_1, and therefore, a description of the PPF circuit 350 will be omitted.

A structure and an operation of the phase interpolator 360 included in the first dummy receiver 300_DM1 are identical to those of the phase interpolator 240 included in the first transmitter 200_1, and therefore, a description of the phase interpolator 360 will be omitted.

The retimer 380 rearranges the bits OT output from the third amplifier 330 and outputs the rearranged bits OT5 (e.g., 2 bits) to the deserializer 390 using the differential clocks OUTP and OUTN output from the phase interpolator 360.

The deserializer 390 deserializes the bits OT5 rearranged by the retimer 380 and generates parallel data OT6 using the differential clocks OUTP and OUTN output from the phase interpolator 360. The deserializer 390 may be a 2:16 deserializer, and may deserialize the 2-bit parallel data OT5 and generates 16-bit parallel data OT6.

According to the embodiment of the present disclosure, a receiver and a transmitter adopting correlated signaling provide a phase interpolator that selects a reference phase of a clock as any one of 0°, 90°, 180°, and 270°, fine-tunes the selected reference phase to any one of 0° to 90°, and generates differential clocks using the fine-tuned reference phase, and a device that can use the differential clocks as synchronous differential clocks, thereby compensating for inter-channel mismatch that may occur in a process of printing channels on a printed circuit board or an integration process.

Moreover, the transmitter and receiver adopting correlated signaling can compensate for inter-channel mismatch, thereby reducing jitter noise caused by the inter-channel mismatch, and achieving the integrity of transmitted and received signals.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A transmitter comprising:
a plurality of serializers; and
a phase interpolator configured to select a reference phase of a clock as one of 0°, 90°, 180°, and 270° using a first code, fine-tune the selected reference phase by adding a phase selected using a second code thereto, and generate differential clocks using the fine-tuned reference phase,
wherein the phase selected using the second code is one of 0° to 90°,
wherein the differential clocks are synchronization clocks of each of the plurality of serializers.

2. The transmitter of claim 1,
wherein the phase interpolator including:
a first differential amplifier configured to select the reference phase as 0° using the first code having a first value, generate a first phase finely tuned between 0° and 90° by amplifying first differential input clocks in response to the second code, and generate the differential clocks using the first phase; and
a second differential amplifier configured to select the reference phase as 90° using the first code having a second value, generate a second phase finely tuned between 90° and 180° by amplifying second differential input clocks in response to the second code, and generate the differential clocks using the second phase.

3. The transmitter of claim 2,
wherein the phase interpolator further including:
a third differential amplifier configured to select the reference phase as 180° using the first code having a third value, generate a third phase finely tuned between 180° and 270° by amplifying the first differential input clocks in response to the second code, and generate the differential clocks using the third phase; and
a fourth differential amplifier configured to select the reference phase as 270° using the first code having a fourth value, generate a fourth phase finely tuned between 270° and 360° by amplifying the second differential input clocks in response to the second code, and generate the differential clocks using the third phase.

4. The transmitter of claim 3,
wherein each of the first differential amplifier and the second differential amplifier is an inverting differential amplifier, and each of the third differential amplifier and the fourth differential amplifier is a non-inverting differential amplifier.

5. The transmitter of claim 1, further comprising:
a plurality of voltage drivers; and
an output terminal connected to an output terminal of each of the plurality of voltage drivers,
wherein each of the plurality of voltage drivers configured to generate an output signal by amplifying a difference between differential signals output from each of the plurality of serializers.

6. The transmitter of claim 5,
wherein a first voltage driver among the plurality of voltage drivers transmits a first output signal, generated by amplifying a difference between first differential signals output from a first serializer among the plurality of serializers and inverting an amplified signal, to the output terminal,
a second voltage driver among the plurality of voltage drivers transmits a second output signal, generated by amplifying a difference between second differential signals output from a second serializer among the plurality of serializers, to the output terminal, and
a third voltage driver among the plurality of voltage drivers transmits a third output signal, generated by amplifying a difference between third differential signals output from a third serializer among the plurality of serializers and inverting an amplified signal, to the output terminal.

7. The transmitter of claim 6,
wherein a first number of unit drivers included in the second voltage driver is greater than a second number of unit drivers included in the third voltage driver, and
wherein the second number is greater than a third number of unit drivers included in the first voltage driver.

8. The transmitter of claim 1, further comprising:
a first shift register configured to shift a first input data in response to the differential clocks to output first parallel bits; and
a second shift register configured to shift a second input data in response to the differential clocks to output second parallel bits,
wherein each of the first parallel bits is input to each of the plurality of serializers, and
wherein each of the second parallel bits is input to each of the plurality of serializers.

9. The transmitter of claim 8,
wherein a first bit of the second parallel bits, which is paired with a first bit of the first parallel bits, is input to a first serializer among the plurality of serializers,
a second bit of the second parallel bits, which is paired with a second bit of the first parallel bits, is input to a second serializer among the plurality of serializers, and
a third bit of the second parallel bits, which is paired with a third bit of the first parallel bits, is input to a third serializer among the plurality of serializers.

10. The transmitter of claim 8, further comprising:
a frequency divider configured to divide a clock having a clock frequency to generate divided clocks having different frequencies;
a first input serializer circuit configured to serialize first parallel data using the divided clocks to generate the first input data; and
a second input serializer circuit configured to serialize second parallel data using the divided clocks to generate the second input data.

11. The transmitter of claim 10,
wherein the divided clocks include a first divided clock obtained by dividing the clock frequency by a first division ratio, a second divided clock obtained by dividing the clock frequency by a second division ratio, and a third divided clock obtained by dividing the clock frequency by a third division ratio,
wherein the first input serializer circuit serializes the first parallel data having N bits using the first divided clock to generate a first input N/2-bit parallel data, serializes the N/2-bit parallel data using the second divided clock to generate a first input N/4-bit parallel data, serializes the N/4-bit parallel data using the third divided clock to generate the first input data corresponding to a first input N/8-bit parallel data,
wherein the second input serializer circuit serializes the second parallel data having N bits using the first divided clock to generate a second input N/2-bit parallel data, serializes the N/2-bit parallel data using the second divided clock to generate a second input N/4-bit parallel data, and serializes the N/4-bit parallel data using the third divided clock to generate the second input data corresponding to a second input N/8 bit parallel data.

12. The transmitter of claim 11,
wherein the first division ratio is greater than the second division ratio, and the second division ratio is greater than the third division ratio.

13. A receiver comprising:
a continuous time linear equalizer configured to receive a first channel signal input through a first channel and a second channel signal input through a second channel;
a current mode amplifier configured to buffer output signals of the continuous time linear equalizer;
a phase interpolator configured to select a reference phase of a clock as one of 0°, 90°, 180°, and 270° using a first code, fine-tune the selected reference phase by adding a selected phase using a second code thereto, and generate differential clocks using the fine-tuned reference phase;
a first comparator configured to compare an output signal of the current mode amplifier with a first reference voltage using the differential clocks and output first bits; and
a second comparator configured to compare the output signal of the current mode amplifier with a second reference voltage using the differential clocks and output second bits.

14. The receiver of claim 13,
wherein the phase interpolator including:
a first differential amplifier configured to generate a first phase finely tuned between 0° and 90° by amplifying first differential input clocks in response to the first code having a first value and the second code, and generate the differential clocks using the first phase;
a second differential amplifier configured to generate a second phase finely tuned between 90° and 180° by amplifying second differential input clocks in response to the first code having a second value and the second code, and generate the differential clocks using the second phase;
a third differential amplifier configured to generate a third phase finely tuned between 180° and 270° by amplifying the first differential input clocks in response to the first code having a third value and the second code, and generate the differential clocks using the third phase; and
a fourth differential amplifier configured to generate a fourth phase finely tuned between 270° and 360° by amplifying the second differential input clocks in response to the first code having a fourth value and the second code, and generate the differential clocks using the fourth phase.

15. The receiver of claim 14, further comprising:
an XOR circuit configured to output third bits by performing an XOR operation on each of the first bits and each of the second bits.

16. An integrated circuit comprising:
a first transmitter;
a second transmitter having the same structure as the first transmitter;
a receiver;
a first communication channel connected between a first output terminal of the first transmitter and a first input terminal of the receiver; and
a second communication channel connected between a second output terminal of the second transmitter and a second input terminal of the receiver,
wherein the first transmitter including:
a plurality of serializers, and
a phase interpolator configured to select a reference phase of a clock as one of 0°, 90°, 180°, and 270° using a first code, fine-tune the selected reference phase by adding a phase selected using a second code thereto, and generate differential clocks using the fine-tuned reference phase,
wherein the phase selected using the second code is any one of 0° to 90°, and
wherein the differential clocks are synchronization clocks of each of the plurality of serializers.

17. The integrated circuit of claim 16,
wherein the phase interpolator including:
a first differential amplifier configured to generate a first phase finely tuned between 0° and 90° by amplifying first differential input clocks in response to the first code having a first value and the second code, and generate the differential clocks using the first phase,
a second differential amplifier configured to generate a second phase finely tuned between 90° and 180° by amplifying second differential input clocks in response to the first code having a second value and the second code, and generate the differential clocks using the second phase;
a third differential amplifier configured to generate a third phase finely tuned between 180° and 270° by amplifying the first differential input clocks in response to the first code having a third value and the second code, and generate the differential clocks using the third phase; and
a fourth differential amplifier configured to generate a fourth phase finely tuned between 270° and 360° by amplifying the second differential input clocks in response to the first code having a fourth value and the second code, and generate the differential clocks using the fourth phase.

18. The integrated circuit of claim 17,
wherein the first transmitter further including:
a first voltage driver configured to transmit a first output signal, generated by amplifying a difference between first differential signals output from a first serializer among the having a fourth value serializers and inverting an amplified signal, to the first output terminal;
a second voltage driver configured to transmit a second output signal, generated by amplifying a difference between second differential signals output from a second serializer among the having a fourth value serializers, to the first output terminal; and
a third voltage driver configured to transmit a third output signal, generated by amplifying a difference between third differential signals output from a third serializer among the having a fourth value serializers and inverting an amplified signal, to the first output terminal.

19. The integrated circuit of claim 18,
wherein a first number of unit drivers included in the second voltage driver is greater than a second number of unit drivers included in the third voltage driver, and
where the second number is greater than a third number of unit drivers included in the first voltage driver.
